(19) United States
(12) Patent Application Publication
(10) Pub. No.: US 2007/0000753 A1
(43) Pub. Date: Jan. 4, 2007

(54) Passenger conveyor drive monitoring arrangement with brake actuation

(76) Inventors: Markus Hame, Stadthagen (DE); Andreas Stuffel, Buckenburg (DE); Thosten Robke, Ninestaedt (DE)

Correspondence Address: CARLSON GASKEY & OLDS, 400 W MAPLE STE 350, BIRMINGHAM, MI, 48009, US

(21) Appl. No.: 10/569,169

(22) PCT Filed: Oct. 29, 2003
(86) PCT No.: PCT/US03/34258

§ 371 Date: Feb. 27, 2006

(51) Int. Cl. B66B 25/00

(52) U.S. Cl. 198/323

(57) ABSTRACT

A passenger conveyor drive assembly (40) includes drive members such as belts (42) that engage a step chain (30). A monitoring device (50) provides an indication of a damaged or broken drive member (42) by monitoring the relative rotations between wheels (44, 46). In one example, relative rotation between deflection wheels (46) provides an indication that one of the drive members (42) is not performing as well as the other. In another example, a comparison between the speed of rotation of the drive wheels (44) on the one hand and the deflection wheels (46) on the other hand allows for independently monitoring each of the drive members (42) of the drive assembly. In a disclosed embodiment, the monitoring device includes rotating members (52, 56) that normally rotate in unison and move into another position when there is relative rotation between the selected wheels. Such movement provides an indication of a malfunction of the drive system and may actuate the brake as needed.

### FIELD OF THE INVENTION

This invention generally relates to passenger conveyor drive systems. More particularly, this invention relates to an arrangement for monitoring the operative condition of a passenger conveyor drive system and for actuating a brake as may be needed.

### DESCRIPTION OF THE RELATED ART

Escalator systems typically include a chain of steps that moves along a loop to carry passengers between landings in different levels of a building, for example. Most escalator systems include at least one drive machine that propels the steps in the desired direction. In many cases, a drive sprocket engages a step chain, which is associated with the steps to cause the desired step movement. Other passenger conveyors have similar or identical arrangements although the steps may move passengers horizontally.

More recently, new drive arrangements have been proposed or introduced. With the introduction of such new systems, the need arises for new techniques for monitoring the operation of the drive system to ensure appropriate performance. Additionally, escalator safety codes require brake actuation in the event of a damaged or failing drive arrangement and new drive systems require new techniques for appropriately actuating a brake.

This invention addresses the need for monitoring the condition of a drive assembly and actuating a brake as may be needed in a passenger conveyor drive arrangement that includes a drive member for moving the step chain.

### SUMMARY OF THE INVENTION

In general terms, this invention is a drive assembly monitoring technique that utilizes relative speeds of sheaves or sprockets as an indication of the condition of the drive assembly.

One example drive assembly includes a plurality of drive wheels. A drive member such as a belt is associated with each drive wheel. Each drive member follows a path around the associated drive wheel and at least one deflection wheel. A monitor device is associated with selected wheels to provide an indication of relative rotation between the selected wheels.

In one example, when there is a difference in the speed of rotation of the selected wheels, the monitor device provides an indication of such relative rotation and facilitates actuating a brake to prevent the steps from moving. In one example, the relative rotation between the sheaves indicates a broken drive member.

One example monitor device includes a first rotating member that is coupled to rotate with the first one of the selected wheels. A second rotating member is coupled to rotate with a second one of the selected wheels. The first and second rotating members begin in a first axial position and remain in that position while the selected wheels rotate at the same speed. At least one of the rotating members moves to a second position responsive to relative rotation between the selected wheels. In one example, the rotating member moves axially relative to the other rotating member when there is a speed difference between the sheaves and, therefore, the rotating members.

As one of the rotating members moves responsive to the speed difference, that movement in one example operates an actuator that, in turn, actuates a brake associated with the escalator system.

The various features and advantages of this invention will become apparent to those skilled in the art from the following detailed description of the currently preferred embodiment. The drawings that accompany the detailed description can be briefly described as follows.

### BRIEF DESCRIPTION OF THE DRAWINGS

FIG. 1 schematically illustrates, in perspective view, selected portions of an escalator system including a drive assembly designed according to an embodiment of this invention.

FIG. 2 is a perspective, schematic illustration of an example drive assembly designed according to an embodiment of this invention.

FIG. 3 illustrates, in somewhat more detail, selected portions of the embodiment of FIG. 2.

FIG. 4 shows the embodiment of FIG. 3 in a second operating position.

FIG. 5 is a perspective, schematic illustration of another example drive assembly designed according to an embodiment of this invention.

### DETAILED DESCRIPTION OF THE PREFERRED EMBODIMENT

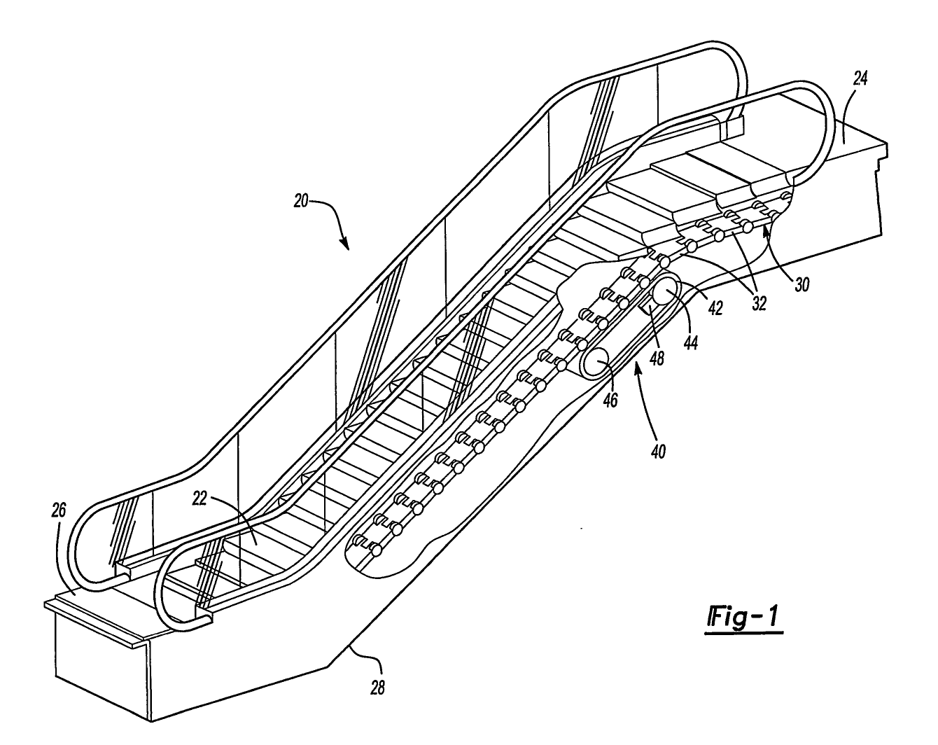

FIG. 1 schematically shows an escalator system 20 having a plurality of steps 22 that move between landings 24 and 26 in a generally known manner. The steps 22 follow a track (not illustrated) that is supported as part of an escalator truss structure 28. A step chain 30 includes a plurality of links 32 that are associated with the steps 22 so that movement of the step chain 30 causes movement of the steps 22.

In the example of FIG. 1, a drive assembly 40 includes a drive member 42 that interacts with the links 32 of the step chain 30 to cause the desired movement of the steps 22. The drive member 42 in one example is a polyurethane belt having reinforcing members such as steel cords. In another example, the drive member 42 comprises a chain. For discussion purposes, the drive member 42 will be referred to as a belt.

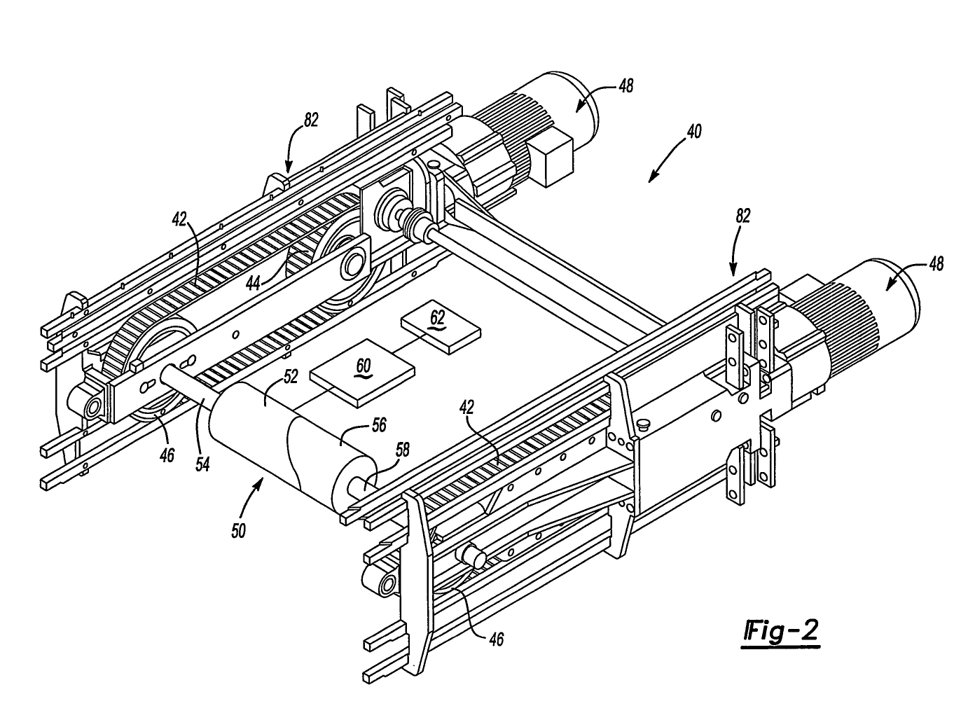

As best appreciated from FIG. 2, the belt 42 preferably is toothed and follows a path defined by a drive wheel 44 and a deflection wheel 46. A machine (i.e., motor and brake) 48 causes movement of the drive wheel 44, which propels the belt 42 around the path and, in turn, propels the step chain 30 and steps 22 in the desired manner. In an example where the drive member 42 comprises a chain, the wheels 44, 46 comprise sprockets. In some examples where drive belts are used, the wheels comprise grooved sheaves.

Although an escalator is shown and discussed, this invention is not limited to escalators. Moving walkways are another example of the conveyors with which this invention may be used.

FIG. 2 schematically illustrates an example drive assembly 40 having two drive members 42. Each drive member 42 is associated with a step chain 30 on the opposite lateral sides of the steps 22. In this example, a machine 48 is associated with each of the drive wheels 44 and the corresponding belts 42. FIG. 2 schematically shows a monitor device 50 that monitors an operating condition of the drive assembly 40. In particular, the monitor device 50 is capable of providing information regarding a condition of the belts 42, such as when one or both of the belts 42 breaks.

In this example, the monitor device 50 includes a first rotating member 52 that rotates with a shaft 54, which rotates with the deflection wheel 46. A second rotating member 56 rotates in unison with a shaft 58, which rotates with the other deflection wheel 46. At least one of the rotating members 52, 56 is associated with a brake actuator 60 that operates to actuate a brake 62: The actuator 60 and brake 62 are schematically shown and comprise known components. The brake 62 may be part of the machine brake or an auxiliary, emergency stopping brake, depending on the needs of a particular situation. The actuator 60 may be electric, cable-based or some combination of these. Those skilled in the art who have the benefit of this description will be able to arrange braking components as needed to meet the needs of their particular situation.

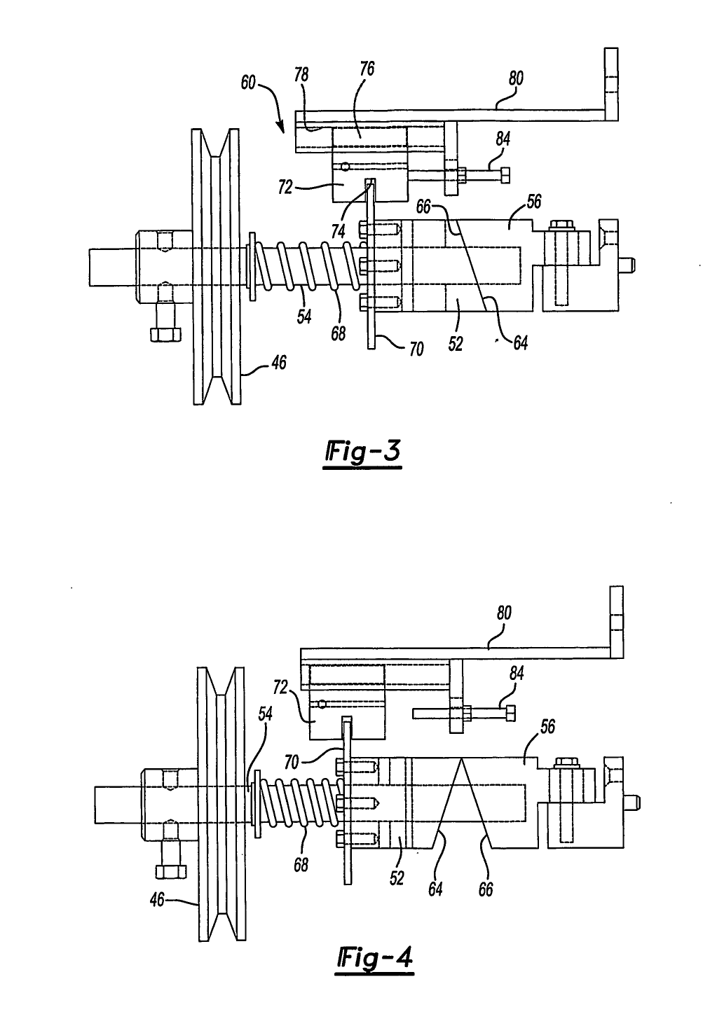

As best seen in FIG. 3, the first rotating member 52 of the example monitoring device 50 is a bushing that rotates with the shaft 54, in unison with rotation of the deflection wheel 46. An engaging surface 64 on the bushing 52 cooperates with a corresponding engaging surface 66 on the second rotating member 56, which also is a bushing in this example. The first rotating member 52 is biased toward the second rotating member 56 such that the engaging surfaces 64 and 66 are aligned as shown in FIG. 3. In this example, the engaging surfaces 64 and 66 are at least partially arranged at an oblique angle relative to the axis of rotation of the rotating members 52 and 56. In this example, a spring 68 biases the first rotating member 52 toward the second rotating member 56.

Under normal operating conditions, the two deflection wheels 46 will rotate at the same speed because the drive wheels 44 are moving synchronously driving the belts 42 in unison. Under such conditions, the first and second rotating members remain in the first position shown in FIG. 3. In the event that one of the belts 42 becomes broken, for example, there will be a difference in the speed of rotation between the deflection wheels 46, because one of them will no longer be driven by the corresponding belt 42 and drive wheel 44. Under these conditions there is relative rotation between the first rotating member 52 and the second rotating member 56. The inclined engaging surfaces 64 and 66 therefore cause relative axial movement between the first rotating member 52 and the second rotating member 56. One position is shown in FIG. 4 where the relative rotation has caused axial movement of the first rotating member 52 relative to the sheave 46 and the second rotating member 56. Such axial movement provides an indication of a malfunction in at least part of the escalator drive system.

In this example, a plate 70 is secured to rotate with the first rotating member 52. As the first rotating member 52 moves axially, the plate 70 causes a follower 72 to move axially as part of the plate 70 is received within a groove 74 on the follower 72. One end 76 of the follower 72 is received to slide within a channel 78 formed on a support 80 as shown. In one example, the support 80 is secured to a selected portion of a drive assembly support structure 82 (FIG. 2), which is associated with the escalator truss 28 in a generally known manner.

The axial movement of the follower 72 can be appreciated by comparing the position of the follower 72 with the setting member 84 in FIG. 3 and FIG. 4. As the follower 72 moves away from the setting member 84, that provides an indication of a malfunction, such as a broken belt condition.

In one example, as the follower 72 moves away from the setting member 84, that triggers the actuator 60 such as throwing a switch (not illustrated) or pulling upon a cable or linkage arrangement (not illustrated) to actuate the brake 62. Those skilled in the art who have the benefit of this description will be able to appropriately arrange the brake actuator portion to cause activation of the brake chosen for their particular situation.

Accordingly, it can be appreciated that the monitoring device 50 provides an indication of a malfunction in the drive assembly, which normally has both belts 42 and all four sheaves 44, 46 rotating at the same speed. In the event that there is any relative rotation between them (i.e., a speed difference between at least two selected wheels), that is an indication of a malfunction in the drive assembly, which may be used to actuate a brake, if desired.

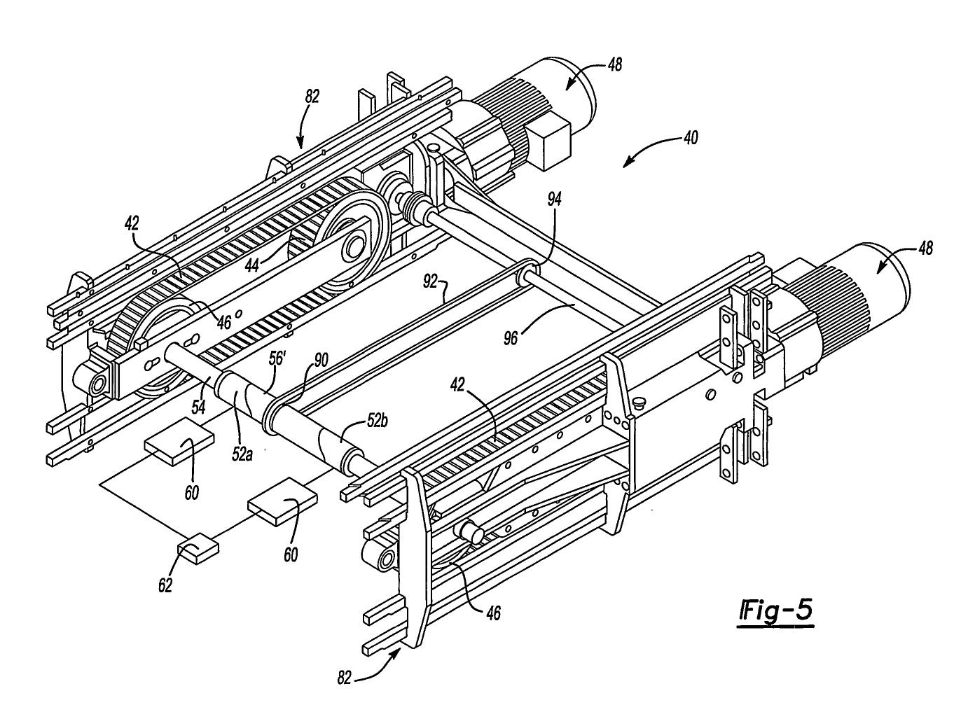

The example embodiment of FIG. 2 is useful for indicating when one of the belts 42 becomes broken or damaged, for example. The embodiment of FIG. 5 is useful for indicating a situation where either belt 42 is damaged or both of the belts 42 are simultaneously broken or damaged. The latter condition may not be fully appreciable using an embodiment as schematically shown in FIG. 2.

Referring to FIG. 5, the modified rotating member 56′ includes a follower portion 90 that is associated with a connector 92, which causes the follower portion 90 to rotate at the same speed as a pulley 94 associated with a synchronizer bar 96 that rotates in unison with the drive wheels 44. In one example, the follower portion 90 comprises a groove on the second rotating member 56. In another example, the follower portion 90 comprises a separate sheave that is arranged to rotate in unison with at least one of the rotating members 52, 56′.

In this example, a single second rotating member 56′ is associated with two first rotating members 52A and 52B. Each of the first rotating members 52A, 52B are associated with a respective one of the deflection wheels 46 to rotate in unison with the associated sheave. In the event that either belt 42 becomes damaged or broken, there will be relative rotation between the drive wheels 44 and the corresponding deflection wheel 46. Under such circumstances, the second rotating member 56′ will rotate relative to the corresponding first rotating member 52 (A or B) causing at least one of the rotating members to move axially as described above. This results in operating the actuator mechanism 60, which in turn may operate a brake as needed.

The embodiment of FIG. 5 allows for separately monitoring each belt 42 or both belts 42 using a single monitoring device arrangement. If both belts 42 broke simultaneously, there would still be relative rotation between the members 56′ and 52A, B.

Another example embodiment includes dedicated first rotating members 52 and second rotating members 56 associated with each deflection wheel 46 and a synchronizing arrangement to cause the rotating members to rotate in unison and at the same speed as the drive wheels 44 under normal operating conditions. Those skilled in the art who have the benefit of this description will realize how to best arrange the components of the monitor device 50 to meet the needs of their particular situation.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of monitoring a passenger conveyor drive assembly (40) having at least one drive member (42) that follows a path around a plurality of wheels (44, 46), comprising:
determining whether selected wheels (44, 46) rotate at the same speed.

2. The method of claim 1, including activating a brake (62) responsive to determining that the wheels (44, 46) rotate at a different speed.

3. The method of claim 1, wherein there are at least two drive members (42) each associated with a deflection wheel (46) and the method includes determining whether the deflection wheels (46) rotate at the same speed.

4. The method of claim 1, wherein there are two drive members (42) each associated with a drive wheel (44) and a deflection wheel (46), the drive wheels (44) synchronously rotating, and the method includes determining whether either deflection wheel (46) rotates at the same speed as the drive wheels (44).

5. The method of claim 1, wherein the member (42) is associated with a drive wheel (44) and a deflection wheel (46) and the method includes determining whether the deflection wheel (46) rotates at the same speed as the drive wheel (44).

6. The method of claim 1, including associating a rotating member (52, 56) with each of the selected wheels (44, 46) such that the rotating members (52, 56) rotate at the same speed as the associated wheels (44, 46), and determining when at least one of the rotating members (52, 56) moves axially responsive to relative rotation between the selected wheels.

7. A passenger conveyor drive assembly (40), comprising:
a plurality of drive wheels (44);
a corresponding plurality of deflection wheels (46);
a drive member (42) associated with each drive wheel (44), each drive member following a path around the associated drive wheel (44) and at least one corresponding deflection wheel (46); and
a monitor device (50) associated with selected ones of the wheels (44, 46) that provides an indication of relative rotation between the selected wheels (44, 46).

8. The assembly of claim 7, wherein the monitor device (50) includes a first rotating member (52) coupled to rotate with a first one of the selected wheels (44, 46) and a second rotating member (56) coupled to rotate with a second one of the selected wheels (44, 46), the first and second rotating members (52, 56) moving relative to each other responsive to relative rotation between the selected wheels (44, 46).

9. The assembly of claim 8, wherein the first and second rotating members (52, 56) comprise bushings having engaging faces (64, 66) that cooperate to cause axial movement of at least one of the bushings responsive to relative rotation between the bushings.

10. The assembly of claim 9, wherein the engaging faces (64, 66) comprise surfaces aligned at least partially at an oblique angle relative to an axis about which the bushings (52) rotate.

11. The assembly of claim 8, wherein one of the rotating members (52, 56) is axially fixed and the other rotating member (52, 56) is biased into a first axial position and wherein relative rotation between the rotating members (52, 56) causes the other rotating member (52, 56) to move axially against the bias.

12. The assembly of claim 11, including a spring (68) that biases the other rotating member (52, 56) into the first axial position.

13. The assembly of claim 8, including a brake actuator (60) associated with at least one of the rotating members, the actuator being operative responsive to axial movement of at least one of the rotating members (52, 56).

14. The assembly of claim 13, wherein the brake actuator (60) includes a follower (72) that follows axial movement of the at least one rotating member (52, 56) and wherein movement of the follower triggers the brake actuator (60).

15. The assembly of claim 8, wherein the selected wheels are two deflection wheels (46) and wherein one of the selected deflection wheels (46) rotates with the first rotating member (52) and the second rotating member (56) rotates with the other selected deflection wheel (46).

16. The assembly of claim 8, wherein the selected wheels are a drive wheel (44) and a deflection wheel (46) and wherein the first rotating member (56) rotates at the same speed as the drive wheel and the second rotating member (52) rotates at the same speed as the selected deflection wheel (46).

17. The assembly of claim 16, including two selected deflection wheels (46) that each have an associated second rotating member (52).

18. The assembly of claim 7, wherein the selected wheels are deflection wheels (46) each associated with a separate drive member (42).

19. The assembly of claim 7, wherein the selected wheels are a drive wheel (44) and a deflection wheel (46).

20. A device (50) for monitoring relative rotations between wheels (44, 46) in a passenger conveyor drive assembly (40), comprising:
a first rotating member (52) for rotating at the same speed as a first selected wheel (44,46);
a second rotating member (56) for rotating at the same speed as a second selected wheel (44, 46), the first and second rotating members (52, 56) changing position relative to each other responsive to relative rotation between the wheels (44, 46).

21. The assembly of claim 20, wherein the first and second rotating members (52, 56) comprise bushings having engaging faces (64, 66) that cooperate to cause axial movement of at least one of the bushings responsive to relative rotation between the bushings.

22. The assembly of claim 21, wherein the engaging faces (64, 66) comprise surfaces aligned at least partially at an oblique angle relative to an axis about which the bushings rotate.

23. The assembly of claim 20, wherein one of the rotating members (52, 56) is axially fixed and the other rotating member (52, 56) is biased into a first axial position and wherein relative rotation between the rotating members (52, 56) causes the other rotating member (52, 56) to move axially against the bias.
